(19) United States
(12) Patent Application Publication
(10) Pub. No.: US 2011/0320524 A1
(43) Pub. Date: Dec. 29, 2011

(54) Technique For Effectively Reducing Latency Of Locating A Resource On A Network

(75) Inventor: Thyagarajan Nandagopal, Edison, NJ (US)

(73) Assignee: Alcatel-Lucent USA Inc., Murray Hill, NJ (US)

(21) Appl. No.: 12/825,699

(22) Filed: Jun. 29, 2010

(51) Int. Cl. G06F 15/16

(52) U.S. Cl. 709/203; 709/245

(57) ABSTRACT

A local domain name system (DNS) server communicates a request for resolving a domain name to a first remote DNS server. The first remote DNS server resolves part of the domain name and relays the request to a second remote DNS server in a hierarchy according to the DNS, thereby obviating the need of repeating by the local DNS server the request to the second remote DNS server. As a result, the latency of locating a network resource by the domain name is reduced.

### FIELD OF THE INVENTION

The invention relates to a technique for locating a resource on a network and, more particularly, to a technique for looking up for a client a network address of one such resource.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

Domain names (e.g., show.my.example.com) are conveniently used to identify and locate resources (e.g., websites, applications, etc.) on a network (e.g., the Internet, an intranet, etc.). This stems from the fact that compared with their numerical address counterparts (e.g., Internet protocol (IP) addresses), domain names are more readily recognizable and memorizable by human. However, in operation a domain name needs to be resolved and translated to the corresponding numerical address before the resource identified by the domain name can actually be accessed via network components, e.g., routers. In accordance with a common domain name system (DNS), a domain name consists of sub-domains differentiated by their levels in a hierarchy. Take the fully qualified domain name (FQDN) “show.my.example.com” for example. The top-level domain of such an FQDN is “corn,” its second-level domain is “example;” its third-level domain is “my;” and its fourth-level domain is “show.” Note that the hierarchy of sub-domains descends from the right to left of an FQDN.

Typically, when accessing a resource on a network using an FQDN, a client would request a local DNS server to resolve such an FQDN. To meet such a request, the local DNS server may consult a hierarchy of remote DNS servers, which may individually resolve the FQDN by its suffixes consisting of incremental sub-domains (e.g., corn, example.com, my.example.com). The latency to resolve an FQDN typically varies from approximately 20 milliseconds to 1 second.

### BRIEF SUMMARY

The invention is premised upon the recognition of a major shortcoming of the typical domain name resolution methodology described above that a request for resolution of a FQDN entails multiple round-trip communications between a local DNS server and individual remote DNS servers. Such round-trip communications likely traverse high-latency links, especially when the distances between the local DNS server and the remote DNS servers are long. In that case, each recursive domain name query and its response via the high-latency links suffer much delay, and the overall delay increases with the number of recursive domain name queries.

In accordance with one embodiment of the invention, after receiving a request for resolving a domain name, a first remote DNS server resolves a first part of the domain name. It then forwards the domain name resolution request to a second remote DNS server capable of resolving a second part of the domain name. The first remote DNS server relates to the second remote DNS server in a hierarchy based on a relation of the first part of the domain name to the second part of the domain name.

Because the domain name resolution request is forwarded by the first remote DNS server to the second remote DNS server, the need of communicating by the local DNS server the request to the second remote DNS server, likely through a high-latency link, is advantageously obviated. As a result, the latency of locating a network resource by the domain name is significantly reduced using the methodology in accordance with the embodiment, relative to that using the typical domain name resolution methodology.

### BRIEF DESCRIPTION OF THE DRAWINGS

FIG. 1 is a block diagram of a system employing a typical domain name resolution methodology;

FIG. 2 is a block diagram of a system employing a domain name resolution methodology in accordance with an embodiment of the invention;

FIG. 3 illustrates a first packet format used in the system of FIG. 2;

FIG. 4 illustrates a second packet format used in the system of FIG. 2;

FIG. 5 illustrates a restricted field in the first packet format in one embodiment;

FIG. 6 is a block diagram of a DNS server in one embodiment; and

FIG. 7 is a flow chart depicting a routine executed in a DNS server in one embodiment.

### DETAILED DESCRIPTION

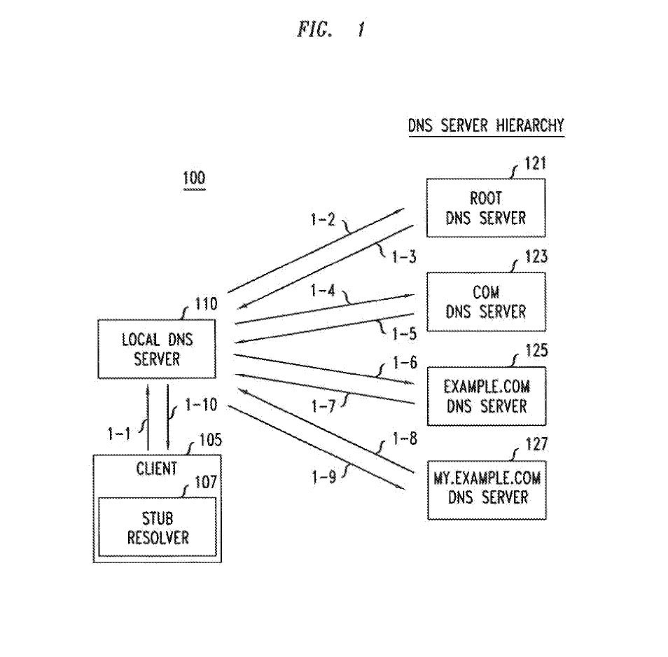

FIG. 1 illustrates system 100 where a typical methodology is employed to resolve a fully qualified domain name (FQDN) (e.g., show.my.example.com) according to a common domain name system (DNS). A user at client 105 (e.g., a personal computer (PC), workstation, terminal, personal digital assistant (PDA), smart phone, etc.) may access a resource (e.g., a website, an application, etc.) on a network (e.g., the Internet, an intranet, etc.) which is identifiable by the FQDN. In operation, the FQDN needs to be resolved and translated, e.g., to an Internet protocol (IP) address before the resource can be accessed via network components, e.g., routers.

Assuming here that the FQDN is being resolved for the very first time, on client 105 stub resolver 107, associated with an end-user application (e.g., a web browser), requests local DNS server 110 to resolve the FQDN (step 1-1). To that end, local server 110 may recursively consult a hierarchy of remote DNS servers which can resolve the FQDN based on its suffixes, respectively. In this example, local DNS server 110 contacts a first remote DNS server in the hierarchy (step 1-2), e.g., root DNS server 121 whose IP address is stored in a file as part of the configuration of local server 110. Remote DNS server 121 in this instance resolves the shortest suffix of the FQDN—the top-level domain “corn,” and returns to local DNS server 110 the IP address of a second remote DNS server—“corn” DNS server 123, and the FQDN in question (step 1-3). Server 121 may be referred to as an “authoritative server” of the “corn” domain as it officially maintains the latest IP address of corn DNS server 123. As the authoritative server, server 121 also informs local DNS server 110 of the expiration time of the corn DNS server's IP address which it has provided.

Upon receipt of the IP address of server 123, its expiration time and the FQDN “show.my.example.com,” local server 110 makes a request for resolution of the FQDN to com DNS server 123 (step 1-4). In response, server 123 in this instance resolves the domain name suffix corresponding to the top-level and second-level domains, i.e., “example.com,” and returns to local DNS server 110 the IP address of a third remote DNS server—“example.com” DNS server 125, and the FQDN in question (step 1-5). Server 123 may be referred to as an “authoritative server” of the “example.com” DNS suffix as it officially maintains the latest IP address of example.com DNS server 125. As the authoritative server, server 123 also informs local DNS server 110 of the expiration time of the example.com DNS server's IP address which it has provided.

Upon receipt of the IP address of server 125, its expiration time and the FQDN “show.my.example.com,” local server 110 makes a request for resolution of the FQDN to example.com DNS server 125 (step 1-6). In response, server 125 in this instance resolves the domain name suffix corresponding to the top-level, second-level and third-level domains, i.e., “my.example.com,” and returns to local DNS server 110 the IP address of a fourth remote DNS server—my.example.com DNS server 127, and the FQDN in question (step 1-7). Server 125 may be referred to as an “authoritative server” of the “my.example.com” DNS suffix as it officially maintains the latest IP address of my.example.com DNS server 127. As the authoritative server, server 125 also informs local DNS server 110 of the expiration time of the my.example.com DNS server's IP address which it has provided.

Upon receipt of the IP address of server 127, its expiration time and the FQDN “show.my.example.com,” local DNS server 110 makes a request for resolution of the FQDN to my.example.com DNS server 127 (step 1-8). In response, server 127 fully resolves the FQDN, i.e., “show.my.example.com,” and returns to local DNS server 110 the IP address of the server (not shown) providing the resource by such an FQDN, and the FQDN in question (step 1-9). Server 127 may be referred to as an “authoritative server” of the “show.my.example.com” FQDN as it officially maintains the latest IP address of the corresponding resource server. As the authoritative server, server 127 also informs local DNS server 110 of the expiration time of the resource server's IP address which it has provided.

Upon receipt of the IP address of the resource server, its expiration time and the FQDN, local DNS server 110 passes such information to stub resolver 107 (step 1-10). Based on the received information, the web browser on client 105 can access the resource server by its IP address for the resource in question.

It should be noted that the IP address of the resource server may be cached at stub resolver 107, in association with its expiration time and the FQDN, to possibly obviate the process of resolving the same FQDN in the future. A cache “hit” is declared when a subsequent request fur resolving that FQDN is received by stub resolver 107, provided that the IP address of the corresponding resource server have not expired.

Similarly, local server 110 caches the IP addresses of the remote DNS servers (e.g., servers 123, 125 and 127) received from the respective authoritative servers, in association with their corresponding expiration times and DNS suffixes, to possibly shortcut any future process of resolving a domain name having one of those DNS suffixes. A cache “hit” is declared when local DNS server 110 is requested to resolve a FQDN having a longest possible DNS suffix matching one of the cached DNS suffixes, provided that the IP address of the DNS server associated with the matched DNS suffix have not expired.

A major shortcoming of the typical domain name resolution methodology described above is that barring any cache hit, a request for resolution of a FQDN entails multiple round-trip communications between a local DNS server (e.g., 110) and individual remote DNS servers (e.g., 121, 123, 125 and 127). It is likely that the local network on which server 110 resides is connected to the remote networks on which servers 121, 123, 125 and 127 reside via high-latency links, especially when the distances between the local network and the remote networks are long. In that case, each recursive domain name query and its response traversing the high-latency links suffer much delay, and the overall delay increases with the number of recursive domain name queries. Further, if the local network is lossy, each query and its response traversing the local network, typically pursuant to the User Datagram Protocol (UDP), are subject to loss and thus retransmission, thereby further delaying the FQDN resolution.

The invention overcomes the above-identified shortcoming by reducing the number of round-trip communications between a local DNS server and remote DNS servers in resolving a domain name. In accordance with one embodiment of the invention, instead of having the local DNS server repetitively send the domain name query to individual remote DNS servers as in the typical methodology, the query is relayed from one remote DNS server to another according to a DNS server hierarchy. Thus, in one embodiment, the otherwise required repetitive communications of the query from the local DNS server to individual remote DNS servers are all eliminated. Advantageously, the delay incurred in a domain name resolution is reduced by at least half in one embodiment, compared with that in applying the typical methodology. In addition, the protocol (e.g., TCP, Reliable UDP, etc.) used to relay a domain name query from one remote DNS server to another in one embodiment affords better communication reliability than the protocol (i.e., UDP) typically used to send the query from the local DNS server to each individual remote DNS server, thereby further reducing the latency to resolve a domain name.

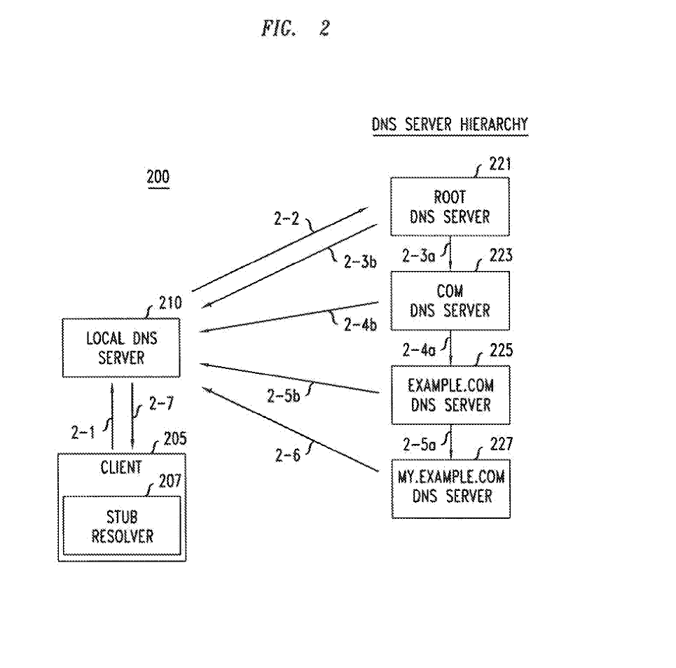

FIG. 2 illustrates system 200 where a domain name resolution methodology embodying the principles of the invention is implemented. To directly contrast system 100 described before, system 200 in this illustrative embodiment employs the inventive methodology to similarly resolve the FQDN “show.my.example.com” for the very first time. Like stub resolver 107, stub resolver 207 in system 200, which is associated with an end-user application (e.g., a web browser) on client 205, requests local DNS server 210 to resolve the FQDN (step 2-1). To that end, like local DNS server 110, local DNS server 210 communicates a query including therein a request for resolving the FQDN to a first remote DNS server (step 2-2), e.g., root DNS server 221, whose IP address is stored in a file as part of the configuration of local DNS server 210.

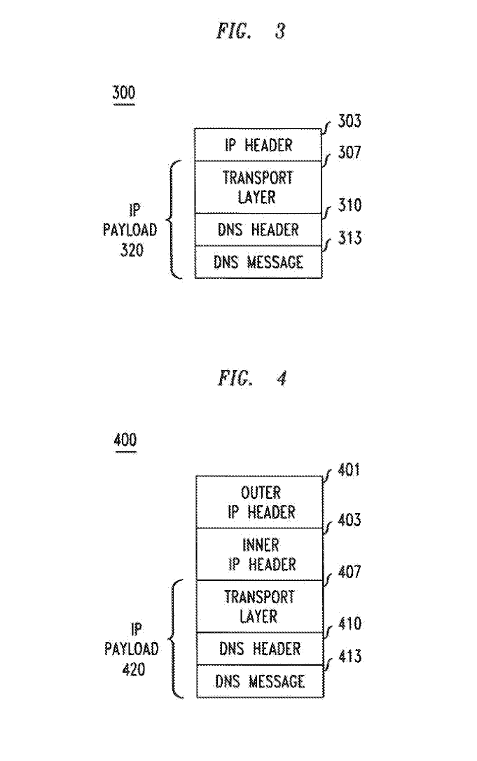

FIG. 3 illustrates packet format 300 typically used for a domain name query in packet form. As illustrated in FIG. 3, packet format 300 includes IP header 303, transport layer 307, DNS header 310 and DNS message 313. Layer 307, header 310 and message 313 collectively may be referred to as “IP payload 320.” In this instance, IP header 303 of the domain name query from local DNS server 210 to remote DNS server 221 contains (a) the IP address of server 210 as the packet originating address and (b) the IP address of server 221 as the packet destination address. Its transport layer 307 in this instance conforms to a UDP transport. Its DNS header 310 in this instance indicates, among other things, that the current packet is of a query nature. Its DNS message 313 in this instance contains a request for resolving the FQDN in question.

Upon receipt of the domain.name query, root DNS server 221 resolves only the top level domain of the FQDN (i.e., the “corn” domain). Because it cannot fully resolve the FQDN, root DNS server 221 in one embodiment of the invention relays the request for resolution of the FQDN to another remote DNS server, e.g., “corn” server 223, according to the DNS server hierarchy. To that end, server 221 transforms the domain name query in packet format 300 to one in packet format 400. As shown in FIG. 4, packet-format 400 includes outer IP header 401, inner IP header 403, transport layer 407, DNS header 410 and DNS message 413.

Specifically, for the domain name query in format 300 received from local DNS server 210, server 221 creates an “IP tunnel” to server 223 by encapsulating the received query with outer IP header 401, which in this instance contains (a) the IP address of server 221 as the packet originating address, and (b) the IP address of server 223 as the packet destination address. In addition, server 221 modifies IP header 303 of the received query to become inner IP header 403 of the query to be relayed to server 223. In one embodiment, inner IP header 403 contains (a) the IP address of local DNS server 210 which remains to be the originating address of the domain name query, and (b) the IP address of server 223 as the destination address of the domain name query. In one embodiment, the contents of IP payload 420 (including layer 407, header 410 and message 413) of the transformed query in format 400 remain unchanged from those of IP payload 320 (including layer 307, header 310 and message 313) of the received query in format 30U. Based on the aforementioned destination address in outer IP header 401, the query in format 400 is relayed (or IP tunneled) to server 223 from server 221 (step 2-3a).

In addition, as an authoritative server of the “corn” domain, server 221 in one embodiment sends an informational packet in format 300 to local DNS server 210 (step 2-3b). This informational packet contains the IP address of corn server 223, and the expiration time of that IP address so that server 210 can cache such information to possibly shortcut a DNS name resolution process in the future. Specifically, the informational packet, in format 300, includes IP header 302 containing (a) the IP address of server 221 as the packet originating address, and (b) the IP address of server 210 as the packet destination address. It also includes transport layer 307 which in this instance conforms to a UDP transport, DNS header 310 which indicates the current packet is of responsive nature, and DNS message 313 which contains the IP address of corn server 233, and the expiration time of that IP address for server 210 to cache.

It should be noted at this point that DNS header 310 also includes Restricted field 503 shown in FIG. 5, which contains three reserved bits 505 traditionally set to “000” according to the well known DNS protocol. However, in accordance with an embodiment of the invention, reserved bits 505 of the informational packet are set to a different code, e.g., “001,” to prevent local DNS server 210, at least for a wait period, from repetitively transmitting the domain name query to a remote DNS server as in step 1-4 of the typical methodology described above. As mentioned before in step 2-3a of this embodiment, such a domain name query is relayed from remote DNS server 221 to remote DNS server 223 via an IP tunnel, instead.

After server 223 receives the domain name query relayed from server 221, it strips outer IP header 401 off the received query, and examines the packet originating address in header 401. For security reasons, in one embodiment a DNS server is programmed to respond only to those queries from a recognized “parent” server in the DNS server hierarchy. Since the packet originating address identifies server 221, a recognized parent to server 223 in this instance, server 223 attempts to respond to the received query. Because server 223 cannot fully resolve the FQDN in question, it similarly relays the domain name query to “example.com” server 225 according to the DNS server hierarchy (step 2-4a). Specifically, server 223 generates the query to server 225 by encapsulating the remainder of the received query with a new outer IP header 401, which contains (a) the IP address of server 223 as the packet originating address, and (b) the IP address of server 225 as the packet destination address. The query generated by server 223 also includes inner IP header 403 containing the IP address of local DNS server 210 which remains to be the originating address of the domain name query, and a new query destination address which is the IP address of server 225. In any event, the query by server 223 has the same IP payload 420 as that of the query received thereby.

In addition, like server 221, server 223 in one embodiment also sends an informational packet in format 300 to local DNS server 210 (step 2-4b), containing the IP address of server 225 and its expiration time for server 210 to cache. Importantly, reserved hits SOS in DNS header 314 of this informational packet are similarly coded “001” to prevent server 210, a least for a wait period, from repetitively transmitting the domain name query to a remote DNS server as in step 1-6.

In general, for each successive remote DNS server S(i) (e.g., server 225) which cannot fully resolve the FQDN in question, it similarly relays the received query to the next server S(i+1) (e.g., server 227) according to the DNS server hierarchy (e.g., step 2-5a), and sends an informational packet including the reserved bit code “001” to local DNS server 210 for caching purposes (e.g., step 2-5b).

When a remote DNS server (e.g., server 227) in the DNS server hierarchy finally resolves the FQDN in question, it looks up the query originating address in inner IP header 403 of the received query, which is the IP address of local DNS server 210 in this instance. Using such an IP address, server 227 sends a response to the domain name query to server 210 (step 2-6), informing the latter of the IP address of the server providing the resource by such an FQDN as in step 1-9 of the typical methodology. Local DNS server 210 passes the received IP address of the resource server to stub resolver 207 (step 2-7). Accordingly, the web browser on client 205 can access the resource server by its IP address for the resource in question.

In one embodiment, instead of using the UDP transport to relay domain name query from a remote DNS server S(i) to server S(i+1), e.g., in steps 2-3a 2-4a and 2-5a, a well known “Reliable UDP” is used for the transport. Although the Reliable UDP transport does not provide in-order delivery of a query, it provides flow/congestion control, and acknowledgement of receipt of a query, and retransmits any lost query to guarantee reliable delivery, subject to timing constraints. This is particularly useful because each domain name query/response mostly is contained within a single packet having less than 512 bytes, which does not require in-order delivery. In accordance with Reliable UDP, each remote DNS server S(i) in the DNS server hierarchy maintains a timeout, Ts, for each query relayed to server S(i+1). If the receipt of the query is not acknowledged by S(i+1) within Ts seconds of transmission, it is retransmitted.

If receipt of the query is not acknowledged by S(i+1) after two retransmissions, the DNS server S(i+1) is considered unreachable. In response, the server S(i) sends an error message to local DNS server 210. This error message may be in packet format 300 whose IP header 303 contains (a) the IP address of server S(i) as the message originating address, and (b) the IP address of server 210 as the message destination address. Its transport layer 307 may conform to a UDP transport. Its DNS header 310 indicates it is of a responsive nature. In this instance, reserved bits 505 in DNS header 310 are set to a code, e.g., “010,” indicating a failure of the query relay process. Its DNS message 313 in this instance contains the IP address of S(i+1), its expiration time, and the original request for resolution of the FQDN.

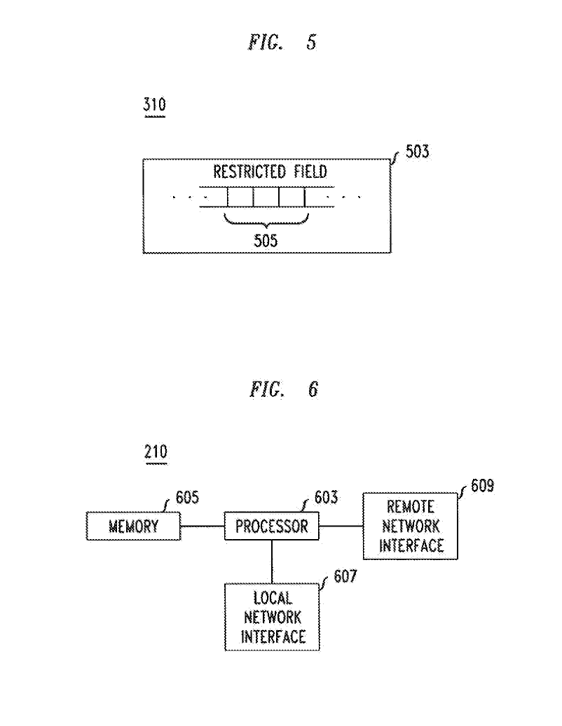

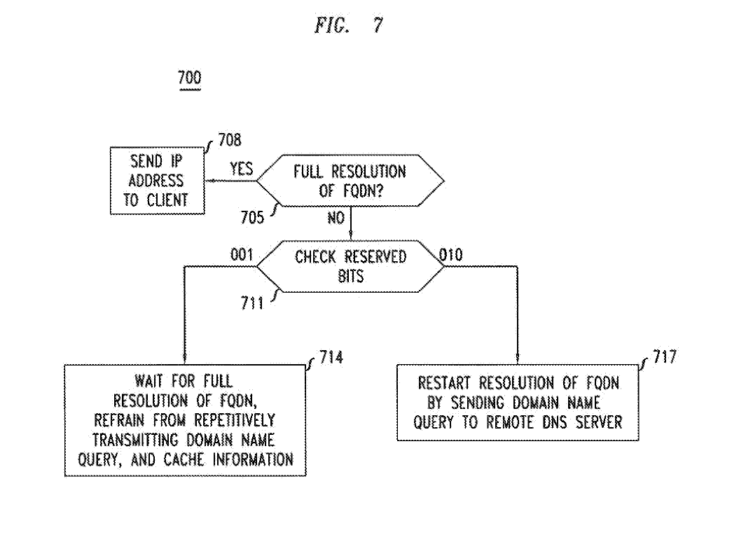

FIG. 6 illustrates local DNS server 210 in accordance with one embodiment of the invention. As shown in FIG. 6, server 210 includes processor 603, memory 605, local network interface 607 for communications, e.g., with client 205, and remote network interface 609 for communications, e.g., with remote DNS servers 221, 223, 225 and 227.

FIG. 7 illustrates routine 700 in server 210 for processing DNS communications in packet format 300 from remote DNS servers, which is stored in memory 605. Instructed by routine 700, processor 603 at step 705 determines whether a received DNS communication through interface 609 provides a full resolution of the FQDN previously requested. If so, processor 603 at step 708 sends the IP address of the server providing the resource identified by the FQDN to client 205 through interface 607. Otherwise, processor 603 at step 711 checks reserved bits 505 in DNS header 307 of the received DNS communication. If the reserved bits are “001,” processor 603 at step 714 waits for the full resolution of the FQDN, refrains from repetitively transmitting the domain name query, and caches information concerning the IP address of a remote DNS server indicated in DNS message 313, and its expiration time. In one embodiment, the wait period is preset after which processor 603 may send, to the IP address just cached, the domain name query, provided that such an IP address have not expired. Otherwise, if the reserved bits are “010,” indicating a failure to relay the query by the remote DNS server S(i) originating the instant error message, processor 603 at step 717 relies on itself to restart the resolution of the FQDN by sending the domain name query to the IP address of the remote DNS server S(i+1) indicated in DNS message 313. Otherwise, if the reserved bits assume other values, processor 603 acts on the received DNS communication in a typical manner according to the well known DNS protocol.

The foregoing merely illustrates the principles of the invention. It will thus be appreciated that those skilled in the art will be able to devise numerous arrangements which embody the principles of the invention and are thus within its spirit and scope.

For example, in a disclosed embodiment, informational packets are provided e.g., in steps 2-3b, 2-4b and 2-5b to local DNS server 210 for IP address caching purposes. However, provisions of such informational packets are optional. That is, it will be appreciated that some or all of such informational packets may not be provided in actual implementations.

In addition, in a disclosed embodiment, Reliable UDP is used for transport of a query from a remote DNS server S(i) to server S(i+1) in accordance with the DNS server hierarchy. It will be appreciated that instead of use of Reliable UDP, other protocols such as the well known transmission control protocol (TCP) affording a more reliable transport than UDP may be used.

Finally, FIG. 6 may also represent structurally other DNS servers (e.g., 221, 223, 225 and 227) than DNS server 210 as disclosed. Although DNS server 210 as disclosed is embodied in the form of various discrete functional blocks, such a server could equally well be embodied in an arrangement in which the functions of any one or more of those blocks or indeed, all of the functions thereof, are realized, for example, by one or more processors or devices.

What is claimed is:

1. A method for use in a server apparatus, comprising:
receiving a request for resolution of a domain name from a first server;
in response to the request, resolving a first part of the domain name; and
forwarding the request to a second server capable of resolving a second part of the domain name, the server apparatus relating to the second server in a hierarchy based on a relation of the first part of the domain name to the second part of the domain name.

2. The method of claim 1 further comprising providing to the first server address information resulting from resolution of the first part of the domain name.

3. The method of claim 1 further comprising creating an IP tunnel through which the request is forwarded.

4. The method of claim 1 further comprising detecting a failure to forward the request to the second server, and communicating the failure to another server after the failure is detected.

5. The method of claim 1 further comprising communicating a network address of the second server to another server.

6. The method of claim 1 wherein the request is forwarded using a Reliable User Datagram Protocol transport.

7. The method of claim 1 wherein the request is forwarded using a Transmission Control Protocol transport.

8. The method of claim 1 wherein the request is forwarded using a User Datagram Protocol transport.

9. The method of claim 1 wherein the first part of the domain name comprises one or more sub-domains.

10. The method of claim 1 wherein the second part of the domain name comprises two or more sub-domains.

11. A server apparatus, comprising:
an interface for receiving a communication from a first server which helps resolve a domain name in response to a previous request by the server apparatus for resolving the domain name, the communication including an indication therein; and
a processor configured to issue to a second server a request for resolving the domain name based on a selected value of the indication in the communication, wherein the first server relates to the second server in a given hierarchy in accordance with a domain name system (DNS).

12. The apparatus of claim 11 comprising a DNS server capable of receiving a request for resolving the domain name from a client.

13. The apparatus of claim 11 wherein the processor is also configured to wait at least a given period for resolution of the domain name without issuing any request for resolving the domain name based on a second value of the indication in the communication,

14. The apparatus of claim 11 wherein the communication includes a DNS header, and the indication comprises selected bits in the DNS header.

15. The apparatus of claim 11 wherein the communication also includes a network address of the second server to be cached in the apparatus.

16. A method for use in a server apparatus, comprising:
receiving a communication from a first server which helps resolve a domain name in response to a previous request by the server apparatus for resolving the domain name, the communication including an indication therein; and
issuing to a second server a request for resolving the domain name based on a selected value of the indication in the communication, wherein the first server relates to the second server in a given hierarchy in accordance with a DNS.

17. The method of claim 16 further comprising waiting at least a given period for resolution of the domain name without issuing any request for resolving the domain name based on a second value of the indication in the communication.

18. The method of claim 16 further comprising receiving a request for resolving the domain name from a client.

19. The method of claim 16 wherein the communication includes a DNS header, and the indication comprises selected bits in the DNS header.

20. The method of claim 16 further comprising caching a network address of the second server in the communication.
